(19) United States
(12) Patent Application Publication
(10) Pub. No.: US 2025/0241348 A1
(43) Pub. Date: Jul. 31, 2025

(54) Lemna (Duckweed) and Other Feedstocks

(71) Applicant: MicroTERRA Biotec INC, New York, NY (US)

(72) Inventors: Vanessa Garfias Silva, Benito Juárez (MX); Rosa Selene Espiricueta Candelaria, Miguel Hidalgo (MX); Salvador García González, Colonia Los Fresnos (MX); Marissa Cuevas Flores, Cuauhtémoc (MX); Karla Paola Medina Torres, Olivar del Conde (MX); Brayan Gabriel Matias Rodriguez, San Francisco Coacalco (MX)

(73) Assignee: MicroTERRA Biotec INC, New York, NY (US)

(21) Appl. No.: 19/041,326

(22) Filed: Jan. 30, 2025

Related U.S. Application Data
(60) Provisional application No. 63/626,702, filed on Jan. 30, 2024.
(60) Provisional application No. 63/627,078, filed on Jan. 31, 2024.

(51) Int. Cl. A23L 27/00; A23C 9/13; A23F 5/46; A23G 9/42; A23L 2/56; A23L 11/60; A23L 23/00; A23L 27/10; C12G 3/06

(52) U.S. Cl. CPC A23L 27/84; A23C 9/1307; A23F 5/465; A23G 9/42; A23L 2/56; A23L 11/60; A23L 23/00; A23L 27/10; A23L 27/86; A23L 27/88; C12G 3/06

(57) ABSTRACT

Preparations and uses of a Lemna extract derived from duckweed are disclosed. These extracts comprise complex blends of volatile and non-volatile compounds, including aromatic compounds such as phenols, flavonoids, and certain terpenes. The extract may contain other constituents such as carbohydrates (e.g. pectin), proteins, fibers, vitamins, minerals, antioxidants, and fatty acids. The Lemna extract composition has properties that make it suitable as a food additive, odorless and flavorless (by itself but it has the ability to enhance other products properties). In an embodiment, when applied to food products (both beverages and solids), the extract effectively masks undesirable aftertastes, modulates and enhances flavors, and/or improves mouthfeel, thereby serving as an excellent food flavor modifier. Various Lemna extracts demonstrate unique functionalities, such as extending melting times, enhancing the quality of ice cream, and intensifying sweetness, further highlighting its versatility as a food modifier.

The present application claims priority under 35 USC 119(e) to US Provisional Application Nos. 63/626,702 filed Jan. 30, 2024, and 63/627,078 filed Jan. 31, 2024, the contents of both of which are herein incorporated by reference in their entireties.

### FIELD OF THE INVENTION

The present invention relates to the preparation and use of a Lemna extract derived from duckweed. This extract comprises a complex blend of volatile and non-volatile compounds, including aromatic compounds such as phenols, flavonoids, and certain terpenes. In addition to other constituents such as carbohydrates (e.g. pectin), proteins, fibers, vitamins, minerals, antioxidants, and fatty acids. The Lemna extract composition has properties that make it suitable as a food additive, odorless and flavorless (by itself). In an embodiment, when applied to food products (both beverages and solids), the extract effectively masks undesirable aftertastes, modulates and enhances flavors, and/or improves mouthfeel, thereby serving as an excellent food flavor modifier. In other embodiments, the Lemna extract demonstrates unique functionalities, such as extending melting times, enhancing the quality of ice cream, and intensifying sweetness, further highlighting its versatility as a food modifier.

### BACKGROUND OF THE INVENTION

Duckweed, a small green aquatic plant, is known for its ability to filter excess nutrients from water bodies, including nitrogen and phosphorus. This fast-growing aquatic plant has attracted attention as a potential solution for water treatment and nutrient management.

Additionally, recent research has highlighted the possibility of utilizing duckweed as a valuable source of fibers and proteins for various applications, including its use as an ingredient in food products.

Duckweed, a member of the Lemnaceae family, comprises five genera (Landoltia, Lemna, Spirodela, Wolffiella, and Wolffia) and a total of 38 known species. Among these, genus Lemna is the most extensively studied and has diverse applications, including wastewater treatment, biofuel production, and use as a protein-rich resource and functional food due to its exceptional nutritional profile. Recently, it has garnered significant attention for its potential role in addressing global food security challenges.

The Lemna genus, commonly known as duckweed, is nutritionally rich, with a dry weight composition that includes up to 15% protein, 4-7% fats, fibers, and 4-10% polysaccharides such as starch. Some species of duckweed, such as Lemna minor, are notable for their high protein content, which ranges from 22-44% of dry matter (Thongthung et al., 2024; Petrova-Tacheva et al., 2020). Studies, such as those by Li et al. (2002), have highlighted the protein-rich nature of L. minor, positioning it as a valuable protein supplement. Additionally, Rojas et al. (2014) demonstrated that Lemna protein concentrate has significant potential as an animal feed protein source, offering metabolizable energy and phosphorus digestibility comparable to fish meal.

Beyond its high protein content, Lemna extracts contain essential nutrients such as amino acids, vitamins, and minerals, which further enhance its nutritional value (Petrova-Tacheva et al., 2020). Cheng and Stomp (2009) emphasized the abundance of vitamins A and C in duckweed, contributing to its nutritional density and making it a promising option for addressing dietary and nutritional challenges.

In addition to its nutritional value, L. minor and other duckweed species contain various bioactive compounds and secondary metabolites with potential human health benefits (Sonmez Gurer & Alǧin Yapar, 2022; Rale et al., 2019). Studies indicate that Lemna sp. can enhance the flavor of tilapia when used as feed (Mayasari et al., 2021) and serve as a substitute for fish meal in shrimp diets (Ma et al., 2014). In poultry, Lemna sp. has been successfully incorporated into the diets of laying hens, maintaining egg production while improving yolk pigmentation (Haustetn et al., 1990). Although traditionally consumed in Southeast Asia, Lemna sp. is gaining attention as a novel food source in Europe (Sosa et al., 2024). However, its applications as a food ingredient and/or additive remain underexplored, particularly regarding its potential uses in flavor modification, flavor enhancement, masking, and improving mouthfeel in food products.

To fully unlock its potential, various methods have been developed for extracting valuable compounds from duckweed species. Protein extraction techniques include trichloroacetic acid/acetone precipitation (Wang et al., 2020), alkaline extraction, and ultrasound-assisted extraction, with the latter being particularly effective in improving yield and functionality (Mirón-Mórida et al., 2024; Nitiwuttithorn et al., 2024). Pectin can be efficiently extracted using Randall's method or microwave hydrolysis (Smyatskaya et al., 2020). Lipid extraction has been optimized through homogenization followed by Soxhlet extraction with a hexane-ethanol mixture (1:1), yielding lipid contents of up to 8% (Smyatskaya et al., 2018). Chlorophyll extraction, meanwhile, is most effective using grinding-elution with 90% acetone (Su et al., 2010).

Research has also focused on the extraction of flavonoids and other bioactive compounds from Lemna. Solvent extraction methods employing ethanol, methanol, chloroform, hexane, and water—individually or in combination—are widely used (Smyatskaya et al., 2018; Wahman et al., 2020; Zhang et al., 2023). Ultrasound-assisted extraction has been shown to enhance efficiency (Zhang et al., 2023), with ethanol-based extractions (20% to 90% ethanol concentrations) being particularly common for isolating flavonoids (Zhang et al., 2023). Enzymatic hydrolysis using enzymes such as Alcalase and Flavorzyme has also been investigated for the extraction of proteins and peptides (Tran et al., 2021).

Extraction outcomes depend heavily on factors such as solvent polarity, pH, and extraction time (Wahman et al., 2020). Advanced analytical techniques like UHPLC-HRMS have enabled untargeted metabolomics profiling, facilitating the identification of a wide range of bioactive compounds (Wahman et al., 2021; Zhang et al., 2023). These compounds include flavonoids, phenolic acids, carotenoids, and glucosinolates, many of which exhibit antioxidant, antimicrobial, and enzyme inhibition properties (Gülçin et al., 2010; González-Rentería et al., 2020). However, reports on the final application of these compounds as food ingredients and/or additives in functional foods and other food matrices remain scarce, underscoring the novelty of this invention.

### BRIEF SUMMARY OF THE INVENTION

The present invention relates to a duckweed-derived extract composition characterized by a complex blend of volatile and non-volatile compounds. These include aromatic compounds, such as phenols, flavonoids, and certain terpenes, which contribute to a pleasant fragrance. Additionally, the composition contains carbohydrates (e.g. pectin), proteins, fibers, vitamins, minerals, antioxidants, and fatty acids. The extract composition has excellent properties that make it ideal as a food additive, odorless and flavorless (by itself), however when applied to food (beverage and solid) it can mask aftertastes, modulate and enhance flavors, and/or increase mouthfeel, thus making it an excellent food flavor modifier. The extract composition, in addition to being a natural flavor enhancer or modulator, can also serve as a masking agent. The composition has also shown the ability to maintain and improve the functional properties in food and beverages, like texture and mouthfeel.

### BRIEF DESCRIPTION OF THE SEVERAL VIEWS OF THE DRAWING

FIG. 1 shows a QDA chart of the stevia in peach juice with and without the masking agent.

FIG. 2 shows the QDA chart of the keto sweetened ice cream.

FIG. 3 shows the QDA chart of the hard seltzer water.

FIG. 4 shows the QDA chart of the double shot of espresso formulated with oats, coconut cream, and vitamins.

FIG. 5 shows the QDA chart of the chamoy with MASK α.

FIG. 6 shows the QDA chart of MASK β added to RTD Nestle.

FIG. 7 shows the QDA chart of MASK β added to the café con leche FIG. 8 shows the QDA chart of adding MASK β to a yogurt (i.e., Yoplait Carson, California).

FIG. 9 shows the QDA chart of adding MASK β to the double espresso.

FIG. 10 shows the QDA chart of MASK α added to Vanilla Pea Protein Drink.

FIG. 11 depicts melting curves for ice cream with a control and FLORA.

FIG. 12 depicts bar graphs of the sweetness amounts of a control and FLORA.

FIG. 13 depicts a bar graph showing the ability of FLORA (the compositional extract and/or isolation product described herein) to add to sweetness potentiation to various sweeteners.

FIG. 14 depicts a bar graph showing the duration of the taste of each sweetener that is evaluated when it has FLORA added to it.

FIG. 15 depicts a bar graph showing the results of the aftertaste evaluation of each sweetener with and without the addition of FLORA.

### DETAILED DESCRIPTION OF THE INVENTION

The present invention relates to the preparation and application of a Lemna extract as a food ingredient and/or additive. This extract comprises a complex blend of volatile and non-volatile compounds, including aromatic compounds such as phenols, flavonoids, and certain terpenes, as well as other constituents like carbohydrates (e.g., pectin), proteins, fibers, vitamins, minerals, antioxidants, and fatty acids. Due to that, the Lemna extract composition is inherently odorless and flavorless, making it particularly suitable as a versatile food additive.

In one embodiment, the invention involves the extraction of a Lemna-derived (MASK α and MASK β) products containing a complex mixture of volatile and non-volatile compounds, including phenols, flavonoids, some terpenes, and other aromatic compounds. When applied to food products, whether beverages or solids, the extract effectively masks undesirable aftertastes, modulates and enhances flavors, and improves mouthfeel, thereby functioning as an exceptional flavor modifier.

Depending on the extraction conditions, the Lemna extract may also contain additional constituents such as carbohydrates (e.g., pectin), proteins, fibers, vitamins, minerals, antioxidants, and fatty acids. In another embodiment, the invention relates to the preparation of a Lemna-derived product (FLORA) enriched in pectin and a combination of fibers and sugars (including pectin). This composition exhibits unique functionalities, such as extending melting times, improving the quality and texture of ice cream, and intensifying sweetness, further demonstrating its versatility and effectiveness as a food modifier.

Typically, the results of many diverse pectin extraction processes from non-citrus peel result in a non-functional product or a product that is not pure enough to be sold (i.e., the product has less than about 65% galacturonic acid). In an embodiment, the present invention relates to an extracted product (FLORA) that comprises pectin with a mix of sugars and fibers, derived from duckweed. This product composition has a special functionality related to flavor modification, flavor enhancement, a masking agent, and improved texture. It also possesses special properties like its ability to increase the melting times and improve quality in ice cream texture and to potentiate or enhance sweetness as a food modifier. However, it should be realized that the addition of the extract of the present invention may provide many unforeseen improvements to food, foodstuffs and other products that are not mentioned herein.

In general, it is discovered that the specific functionality as described herein was heretofore unknown. It is discovered that the extracts described herein are very good as flavor modulators, (or enhancers), taste modulators and masking agents. Until now, there had been no evidence of flavor modulators, flavor enhancers or masking agents derived from duckweed, however, it was known that duckweed could potentially be used for protein extracts.

The present invention introduces an innovative approach that not only supports the sustainable management of water resources but also provides a novel pathway for developing sustainable food ingredients and/or additives. In one embodiment, the invention harnesses the natural properties of Lemna sp. to establish a cost-effective and environmentally sustainable process for extracting natural compounds, including aromatic substances such as phenols, flavonoids, and certain terpenes. Additionally, the extract composition contains pectin, other carbohydrates, proteins, fibers, vitamins, minerals, antioxidants, fatty acids, and other bioactive compounds, which serve as functional and nutritional components in various food products. This innovation directly addresses the increasing demand for sustainable, health-conscious ingredients in the food industry.

Compositions that are High in Volatile and Non-Volatile Compounds

One of the standout features of Lemna sp. is its profile of volatile and non-volatile compounds. Among the volatile compounds, Lemna sp. contains a variety of aldehydes, alcohols, and esters, which significantly contribute to its unique aroma and its flavor. These volatile compounds may be valuable for enhancing sensory characteristics in food applications, such as flavor modulation, flavor enhancement, and masking of aftertaste. Additionally, the non-volatile compounds that are present in Lemna sp., such as flavonoids, tannins, and other secondary metabolites, offer antioxidant properties and health benefits, further enhancing its nutritional and functional value.

Despite this potential, Lemna sp. or other genera has not been fully utilized as a source of these bioactive compounds. Furthermore, Lemna sp. extract also contains minerals, fatty acids, vitamins, and other useful compounds that may be beneficial in food products and other applications. Thus, Lemna extracts remains an underutilized source of volatile and non-volatile compounds with potential applications in the development of functional foods and nutraceutical products.

In one embodiment, the present invention allows for an optional pre-treatment step that stabilized the feedstock material, extending its shelf life to at least 54 days. This process optimizes Lemna sp. (duckweed) for the extraction of a unique composition of components, which provide the functional advantages described herein.

In a variation, the feedstock material contains a specific blend of carbohydrates that exhibit specialized functionalities, which are difficult to obtain from other sources. To harness these properties, the invention incorporates a pre-treatment stage to condition the feedstock material. For the MASK α and MASK β products, steps 1 to 3 below are relevant. For the FLORA product, all the steps outlined below are applicable.

### Pre-Treatment

1. Harvesting: Harvest the feedstock material from the pond (example: Lemna sp.).
2. Draining: Transfer the plant material onto a mesh with a pore size suitable for retaining the plant while allowing water to gravity-filter until reaching a solids content of 4-15%, or alternatively, 5-8%.
3. Grinding: Grind the feedstock with a grinder mill; until obtaining a homogeneous Lemna mixture
4. Preservation: Add food-grade sodium benzoate at a concentration of 0.1-1.0% per kg and EDTA at 0.05-0.5%, or alternatively, approximately 0.2% per kg of feedstock material.
5. pH Adjustment: Adjust the pH of the Lemna mixture to a value between 1 and 6, or alternatively, between 1 and 3.5, to create an acidic suspension.
6. Storage: Store the Lemna mixture (containing additives and water) for at least 1 day, or alternatively, for 2, 3, 4, 5, 6, or 7 days.
7. Cell Wall Breakdown: After at least 1 day (or up to 7 days) of storage in an acidic environment, maceration facilitates the pre-breakdown of plant cell walls. This process, combined with the added auxiliary agents, enhances the efficient release of target compounds such as pectin and fibers.

In an embodiment, duckweed (for example, Lemna minor and/or Lemna gibba, or mixtures thereof) emerges as a nutritional powerhouse with a balanced composition of volatile and non-volatile compounds. Among these are aromatic compounds, such as phenols, flavonoids, and certain terpenes, which contribute to a pleasant fragrance. Additionally, the composition includes pectin, other carbohydrates, proteins, fibers, vitamins, minerals, antioxidants, and fatty acids. Although there have been scientific studies that suggest duckweed may provide a nutritional richness and suggest its potential as a sustainable and versatile source of nutrition for both human and animal consumption, to the inventors' knowledge, this postulated potential has not yet been untapped. As the world grapples with the challenge of feeding a growing population sustainably, duckweed stands out as a promising candidate to meet the demands of a nutritionally conscious and environmentally aware global society.

In an embodiment, several different extracts can be accomplished by utilizing various extraction methods. Two principal products have been generated using different extraction methods with those two products being MASK (which includes MASK α and MASK β), which is primarily extracted by use of an aqueous extraction process and FLORA, which also uses an aqueous extraction process with auxiliary agents.

Depending on the use of the Lemna sp. extract as a food additive, in the present invention one of these two extraction codifications can be used.

### Extraction 1. MASK α and MASK β

1. Preparation of reaction—Add fresh Lemna mixture and potable water to the reaction vessel, wherein the ratio of feedstock to water ranges from 1:0 to 1:5.
2. Extraction process: The extraction is conducted at a temperature between 35° C. to 110° C. for a period of 40 to 120 minutes, with continuous agitation to ensure uniform extraction. Agitation may be performed using mechanical stirrers, magnetic stirrers, or high-shear mixers.
3. Post-Reaction Procedure: Cool the mixture to a temperature between 18° C. and 24° C. using cooling jackets, water baths, or refrigeration units.
4. Separation of Liquid and Residue: Separate the liquid from the solid residue using separation methods paper filter, decantation, or centrifugation.
5. Treatment of Liquid with Activated Carbon and Celite: Transfer the obtained liquid to a suitable agitation container, such as a glass beaker or stainless-steel mixing tank and measure the volume of the liquid. Add activated carbon and celite at a concentration ranging from 0.2% to 5%. The additives are mixed using a mechanical agitator or overhead stirrer.
   a. Disperse the additives by maintaining continuous agitation for a period of 15 to 25 minutes, with a range of 10 to 30 minutes. Agitation may be performed using mechanical stirrers, magnetic stir bars, or high-shear mixers.
   b. Filter the liquid to remove the celite and activated carbon using separation methods like filter press, centrifugation, gravitational filtration, or any other suitable separation process.
6. Clarification and Stabilization of the Liquid: Perform a clarification process to obtain a clear, particulate-free liquid, wherein the clarification is achieved using methods such as: filtration, sedimentation, vacuum filtration, centrifugation, and membrane filtration. Evaporation of clarified liquid: Evaporate the clarified liquid until a solids content of 5% to 7% is obtained, using methods such as: rotary evaporator, falling film evaporator, and concentration by boiling.
7. Stabilize the concentrated and clarified liquid by adding propylene glycol, glycerol, sorbitol, ethanol, or other stabilizing agents in a ratio ranging from 0.5:1 to 1.5:1. The stabilizing agent may be added manually or automatically.

### Extraction 2. FLORA

1. Stabilization and coagulation: add 10-30% of food-grade sodium hexametaphosphate (dry basis), EDTA, Citric Acid dissolved in water to the stabilized Lemna mixture. Other coagulators aside or combinations thereof can be used.
2. Mixing and Heating: Mix y and heat it to a temperature the Lemna mixture between about 60° C. to 95° C. for 30 minutes to about 200 minutes to facilitate the dissolution of coagulant agent.
3. Adjust the pH and hydrolysis: Adjust the pH of the Lemna mixture to a range of about 1-5 with HCl, and initiate the hydrolysis process to further break down the cell wall components and enable the solubilization of fiber, fatty acids, carbohydrates, proteins, minerals, and vitamins of interest in the solution. The hydrolysis is performed at 50-92° C. for 60-120 mins.
4. Stop the hydrolysis: stop the hydrolysis with a cold water bath until the mix has reached 15-25° C.
5. Filtration and separation: Filter the resulting Lemna mixture to separate fiber from the liquor (acid liquor).
6. Perform ethanol precipitation: Treat the acid liquor phase with 96% ethanol, and in an embodiment, excess ethanol, allowing precipitation under refrigeration.
7. Filtration and separation: Filter the resulting to separate precipitated solid from acid liquor.
8. Drying of fiber product: Dry the product at elevated temperature, and in an embodiment at 35-65° C., or alternatively and/or additionally, using a spray drier, a vacuum drier and/or stove.
9. Grinding and storage: Grind the dried fiber to a specific consistency and store it under controlled conditions to maintain its quality and integrity away from light and moisture.

### MASK α and MASK β.

MASK α is a natural Lemna sp. extract with masking properties that can rebalance the sensory profile of a product. The product generally comprises a Lemna sp. extract and glycerol. The MASK α product is a liquid that is amber in color, and has an odor and taste that conform to standards. Generally, it can be used with a product as an additive at 0.05-0.15% by weight of the total product plus MASK α. MASK α can be used to mask off-notes, aftertaste, metallic flavors, and bitterness of products with alternative proteins like drinks and plant-based meats. It can also be used for applications with vitamins and minerals. One additional use is for applications wherein one is looking for improved mouthfeel and creaminess. MASK α has a shelf life of about a year, and it can be readily packaged, such as in 60 g food grade using HDP (high density polypropylene). MASK α should be stored in a cool dry environment and protected from direct sunlight. The packaging should be tightly closed when not being used. MASK α has the following chemical parameters: a pH of 6.29-6.5, a brix refractometer reading of 42-43, The MASK α product also tests negative for the following common allergens: Cereals containing gluten and gliadin, Soybeans and products thereof, milk and products thereof, peanuts and products thereof, nuts such as almonds and products thereof.

MASK β is also a natural Lemna sp. extract with masking properties that can rebalance the organoleptic profile of a product. The product generally comprises a Lemna sp. extract and glycerol. The MASK β product is a liquid that is amber in color and has an odor and taste that conform to standards. Generally, it can be used with a product as an additive at 0.015-0.030% by weight of the total product plus MASK β. MASK β can be used to mask bitterness, metallic notes, and aftertastes of products using high-intensity sweeteners. It can also be used for applications wherein a need to increase sweetness perception is present, to enhance fruity flavors, and/or to create a more natural flavor profile. MASK β has a shelf life of about a year, and it can be readily packaged, such as in anything between 10 grams to 20 kg or in 5 kg or 20 kg/Gal g food grade using HDPE (high density polyethylene). MASK β should be stored in a cool dry environment and protected from direct sunlight. The packaging should be tightly closed when not being used. MASK β has the following chemical parameters: a pH of 6.29-6.5 (in water), and a brix refractometer reading of 42-43.

The liquid product has one or more of the qualities described above. The liquid product (which is a composition of various components) is amber in color, it comprises a flavor modulating plant product that provides both flavor and mouthfeel when added to food products, and it has a pH of between about 6-8. The product is low in arsenic, lead, mercury, and cadmium with a ppm less than about 3 ppm, or alternatively less than about 1 ppm. The product may possess sodium at amounts that are more than 3000 ppm. The product is low in coliforms, Staphylococcus aureus, fungus, molds, yeast and E. coli with ppm levels at or below 10 ppm, or alternatively below about 3 ppm of for E. coli below 3 CFU/mL, for Staphylococcus aureus below 100 CFU/mL for Salmonella negative (not found), and for Clostridium perfingens below CFU/mL. In an embodiment, the product should be protected from light, heat and humidity. In an embodiment, the shelf life of the product may be as long as one year if light, heat and humidity are reduced and the product is kept in a stored container. Moreover, the product that is generated does not have any of the known allergens associated with it: cereals containing gluten and gliadin, soybeans and products thereof, milk and products thereof, peanuts and products thereof, nuts, almond and products thereof.

MASK improves on other products currently on the market that have problems like lacking taste, or having off tastes or bitter aftertastes. The other functional products may lead to a loss of mouthfeel. Moreover, MASK is superior because it is a natural product unlike other products, which may be synthetic.

MASK is advantageous in that it enables food and beverage companies to produce zero sugar and plant based products without compromising taste or mouthfeel. The natural clean MASK label extract masks unwanted off-notes, aftertaste, and bitterness from high-intensity sweeteners, plant-based proteins, vitamins and minerals, amino acids, caffeine and more. MASK is able to block unwanted flavors and is able to enhance the sensory experience, like improved mouthfeel. MASK may also improve taste, masks off-notes while maintaining a clean label. It can be incorporated at low dosage amounts and is very easy to incorporate into formulations. MASK works well with alternative sweeteners, complementing their sweetening while masking their off taste, bitterness, and improving astringency. MASK works well with functional beverages, masking off notes from added proteins, minerals, and vitamins, as well as high intensity sweeteners in functional beverages. MASK also works well with plant-based proteins, masking the “bean-like, bitter, “cardboard-like”, and “earthy” tastes of these proteins.

Products to which MASK can be added include but are not limited to drinks (such as tea, soft drinks, etc.) yogurts, Jell-O (gelatine products), sauces/condiments (such as ketchup, barbeque sauce, etc.), beverages such as functional beverages, vitamin-enhanced drinks, caffeinated drinks, energy and sports drinks, and low calorie alcoholic drinks, plant based proteins such as plant-based non-dairy products, and protein drinks.

MASK is made from Lemna sp., a tiny but mighty aquatic plant, which can be grown by cleaning water. Lemna sp. can be grown using greenhouse wastewater. In a variation, greenhouse wastewater is water used in food production. The Lemna sp. that is grown is then subject to an extraction process. The extraction product (e.g., MASK) can then be added to zero sugar products or other food and beverage products that have off notes, aftertastes or unwanted flavors.

Without being bound by theory, MASK works in one or more dimensions such as by blocking and/or suppressing taste receptors to avoid off tastes and/or bad flavors (such as bitterness) and/or works by using aromatic compounds to modulate the flavors and “distract the brain” from perceiving the undesirable flavors (such as some negative flavors associated with after taste).

Two separate MASK products, MASK α and MASK β, can be made, with the difference between the two being different inclusion amounts of aromatic compounds. Although two separate MASK products have been used, there can be a plurality of different masking products that can be made simply by altering the amounts of aromatic compounds. It has been found that the MASK α and MASK β when used in products at 0.05%-0.15%, and 0.01%-0.03%, amount respectively, gives good masking ability. MASK α is designed to be used with alternative proteins, plant-based meats, as well with vitamins and mineral enhanced products. MASK β is designed to be used with beverages sweetened with alternative sweeteners (such as stevia, aspartame, acesulfame potassium, sucralose, neotame, saccharin, advantame, cyclamate, xylitol, sorbitol, etc.), and other kinds of carbonated and non-carbonated beverages.

### MASK Examples

### Objective

The following experiments demonstrate the functionality of the MASK powdered version evaluated in a known matrix (standardized tea) using a triangular test, analyzed by Chi-Square statistic.

### Materials

The materials employed in this study comprised the following:
Powder MASK
Liquid MASK
Standardized tea
Cups
Palate cleansers (water and whole wheat crackers)

### Experimental Procedure

For the release of extract lots, 12 judges were trained in sensory discrimination methodologies (particularly in a Triangle Test methodology) to ensure that each judge could discriminate between samples in case there were differences.

For each lot release, the following applications are performed:
1. Preparation of evaluation matrix

### Ingredients:

For the tea concentrate
500 g of water
2 lemon tea bags
2 green tea bags

For the final mix
250.0 g of tea concentrate
10.0 g of apple juice
20.0 g of sugar
0.13 g of stevia
1 g of citric acid
0.35 g of potassium sorbate
218.36 g of water

### Instructions:

The following steps were taken in preparation of ascertaining the effectiveness of the masking agent.

### I. Prepare the Tea Concentrate:

A. Heat 500 g of water to 80° C.
B. Add the 2 lemon tea bags and 2 green tea bags to the hot water.
C. Mix for 3.5 minutes at the Thermomix speed of 1.5 using the reverse function (mix with paddle).
D. After mixing time, recover the evaporated water to maintain a total of 500 g.

### II. Mix the Final Ingredients:

A. Add 250.0 g of the prepared tea concentrate to a mixing bowl.
B. Add 10 g of apple juice, 20 g of sugar, 0.13 g of Stevia Green Concept, 1 g of citric acid, and 0.35 g of potassium sorbate.
C. Add 218.36 g of water to complete the volume.
D. Mix well until all ingredients are completely dissolved.
2. Apply the 0.1% liquid MASK in the evaluation matrix.
3. Apply MASKin powder at 0.17% in the evaluation matrix
4. Prepare the samples for the Triangle Test.

Each judge is presented with a series of three samples, randomly coded. In this series, two of the samples are the same, and one is different (usually, the two identical samples are control samples, and the different sample is the lot to be released).

The judge must taste each series with the goal of discriminating which of the three samples is the different one. This procedure will be carried out:
a) In duplicate,
b) For each of the lots that are to be released.

### Results and Data Analysis

The results of the tests were analyzed using a Chi-squared statistical test, wherein a theoretical value was calculated and was shown to be (2.71). The theoretical value was compared to the experimental (calculated) value. If the experimentally obtained value is greater than the theoretical value, the conclusion is that there is a significant difference between the samples and the masking is not effective. Therefore, each produced lot must undergo this evaluation to ensure that there is no difference in the extract, allowing it to be released.

The chi-squared test gave the results shown in the below table 1.

TABLE 1
Sensorial Panel Results

| | | | | | Chi- |
|---|---|---|---|---|---|
| Batch ID | | Not | | Trial | Squared |
| Batch | Production | detected | Detected | Total | value |
| Example | | 2 | 5 | 7 | 3.146 |
| Example | | 5 | 2 | 7 | 0.430 |
| 1S | MT | 6 | 6 | 12 | 0.907 |
| 2S | MT | 9 | 3 | 12 | 0.816 |
| 3S | MT | 5 | 7 | 12 | 2.468 |

All but the first example showed chi-squared values that fell below the theoretical value showing that the masking by both the liquid MASK and the powder MASK could not be differentiated and that both were effective.

### Masking Tests on Products

Masking tests were performed on the following products to ascertain the ability of the masking agent to mask various characteristics of the products tested. The products tested include stevia, coffee, sweeteners, specifically agave syrup and stevia, double shot of espresso with oats, coconut cream, and vitamins, chamoy come verde, Yoplait yogurt, and a soy drink.

The general testing procedure was as follows:

A panel of 5-15 participants performed a blind test comparing the attributes of the control sample with the sample containing MASK. The participants evaluated the differences between one or more of the following attributes: sweetness, acidity, spiciness, aftertaste, bitterness, bitterness (from sweeteners), coffee notes, bean notes green notes, caramel notes, milk notes, vanilla flavor, metallic taste (stevia), natural profile, pulpy notes, fruity notes, blueberry notes, berries notes, pulpy notes, alcohol notes, astringency, toasted notes, mouthfeel, impact on smell, impact on mouthfeel, impact on taste.

The most relevant attributes for the various products as listed above were scored on a 0-scale, with 0 indicating complete masking and 10 indicating no masking and participants rated the respective products in the absence of the masking agent (i.e., the control) and in its presence.

### MASK β Added to Peach Juice Containing Stevia

The objective of this project was to reduce the characteristic bitterness of Stevia, which prevents beverages from being consumed in larger quantities due to the lingering and unpleasant aftertaste it leaves over time.

### Control Formulation

| | Sample | |
|---|---|---|
| | Size | |
| | (g) | 100 g |
| Ingredients | % | g |
| Peach juice containing stevia | 100 | 100 |
| Total | 100.00 | 100.00 |

Sample with MASK β

| | Sample | |
|---|---|---|
| | Size | |
| | (g) | 100 |
| Ingredients | % | g |
| Peach juice containing stevia | 99.985 | 99.985 |
| MASK β | 0.015 | 0.015 |
| Total | 100.00 | 100.00 |

A panel of 15 participants performed a blind test comparing the attributes of the control sample with the sample containing MASK β. They evaluated the differences between the following attributes: sweetness, bitterness, metallic (stevia), natural profile, pulpy Notes, fruity Notes, impact on smell, impact on taste.

All of these attributes are scored on a scale from 0-10 in terms of how they are perceived by the panel.

For stevia in peach juice, the following conclusions were reached.

The masking agent increases sweetness, making the beverage more balanced without sharp sweetness peaks. It significantly reduced the bitterness and metallic taste caused by stevia. It caused the juice flavor to be perceived as more natural and fleshy, with a peach-like taste. It enhanced the aroma of the beverage, causing it to be perceived as fresh juice. It increased the overall flavor rating from 5 to 10, with a notable improvement in taste.

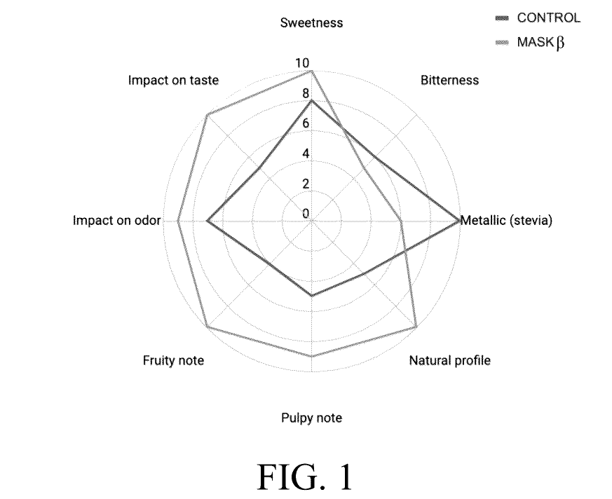

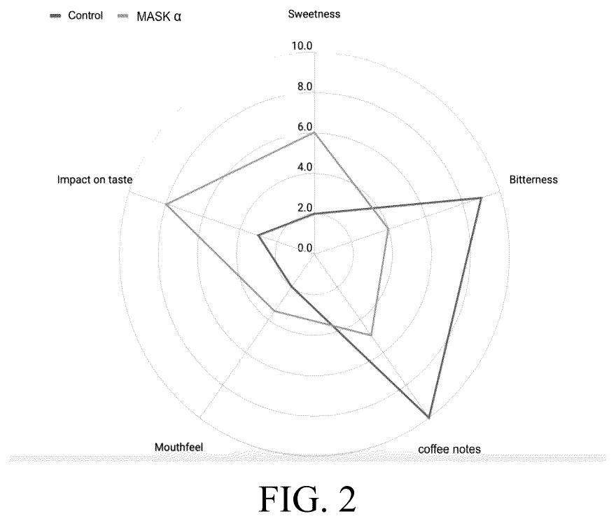

FIG. 1 (as are FIGS. 2-10) is representative of a QDA chart summarizing the difference between the control sample and the sample containing 0.015% of MASK β for the peach juice embodiment.

MASK α added to Keto Ice Cream

The objective is to improve both the texture and flavor. The bitter taste of the coffee is excessively intense. Due to the fact that the product is a keto ice cream sweetened with monk fruit and lactose-free, the ice cream has a low texture profile and an extremely intense coffee flavor, as it contains ground coffee beans.

### Control Formulation

| | Sample Size (g) | 100 |
|---|---|---|
| Ingredients | % | g |
| Coffee ice-ream “BowlBar” | 100 | 100 |
| Total | 100.00 | 100.00 |

Sample with MASK α

| | Sample Size (g) | 100 |
|---|---|---|
| Ingredients | % | g |
| Coffee ice-cream “BowlBar” | 99.65 | 99.65 |
| MASK α | 0.35 | 0.35 |
| Total | 100.00 | 100.00 |

A panel of 5 participants performed a blind test comparing the attributes of the control sample with the sample containing MASK α. They evaluated the differences between the following attributes: sweetness, bitterness, coffee notes, impact on mouthfeel, impact on taste. All of these attributes are scored on a scale from 0-10 in terms of how they are perceived by the panel. For the keto sweetened ice cream, the following conclusions were reached.

The greatest impact of MASK α is observed in the bitterness of the coffee. Initially, the flavor is very intense, with a burnt coffee taste. Adding MASK α softens these notes, creating a much rounder flavor profile with a more pronounced sweetness.

The coffee flavor is still present but is less intense compared to the control ice cream.

In terms of texture, a slight change in the “meltability” of the ice cream was observed. The ice cream also felt creamier after the addition of MASK α.

FIG. 2 presents a QDA chart describing the difference between the control sample and the sample containing 0.35% of MASK α.

### MASK β Added to Blueberry Flavored Hard Seltzer Water

The objective of this project was to eliminate the aftertaste of sweeteners, specifically agave syrup and stevia, while enhancing the fruity flavor of the blueberry.

### Control Formulation

| | Sample Size (g) | 100 |
|---|---|---|
| Ingredients | % | g |
| Palmar Spritz Ultra | 100 | 100 |
| Total | 100.00 | 100.00 |

Sample with MASK β

| | Sample Size (g) | 100 |
|---|---|---|
| Ingredients | % | g |
| Palmar Spritz Ultra | 99.985 | 99.985 |
| MASK β | 0.015 | 0.015 |
| Total | 100.00 | 100.00 |

A panel of 10 participants performed a blind test comparing the attributes of the control sample with the sample containing MASK. They evaluated the differences between the following attributes: sweetness, bitterness, acidity, blueberry Notes, alcoholic notes, astringency, impact on mouthfeel, impact on smell, impact on taste.

All of these attributes are scored on a scale from 0-10 in terms of how they are perceived by the panel.

For the blueberry flavored hard seltzer water, the following conclusions were reached with the addition of the masking agent.

The formulation with the masking agent enhanced both the flavor and aroma, making the overall sensory experience more vibrant.

The bitterness from stevia was minimized, resulting in a smoother and more balanced flavor.

The natural fruit notes were more pronounced, improving the beverage's overall flavor profile. The intensity of the alcohol flavor was slightly reduced, leading to a smoother taste.

The astringent sensation was lessened, resulting in a more refined mouthfeel.

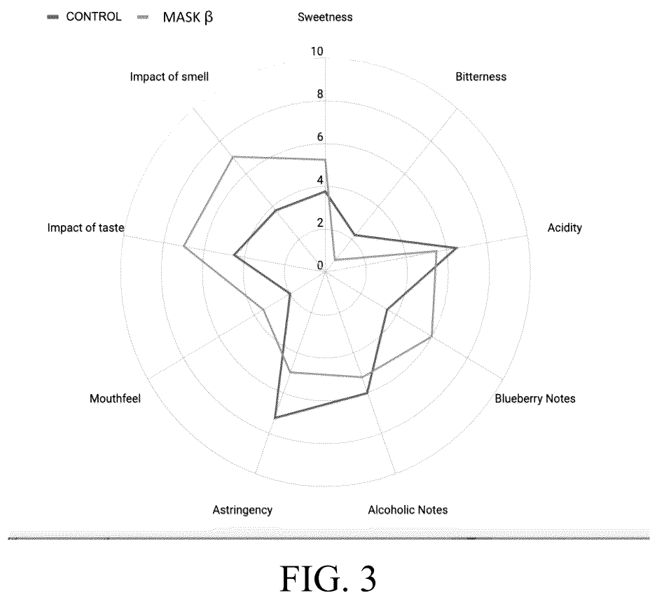

FIG. 3 presents a QDA chart describing the difference between the control sample and the sample containing 0.015% of MASK β.

Double Shot of Espresso Formulated with Oats, Coconut Cream, and Vitamins

For this beverage formulated with oats, coconut cream, and vitamins, the objective is to use MASK β to eliminate any aftertastes that these ingredients may leave, as well as to improve the sensory experience in terms of texture, while simultaneously enhancing the flavor profile of the drink.

### Control Formulation

| | Sample Size (g) | 100 |
|---|---|---|
| Ingredients | % | g |
| Doble shot espresso | 100 | 100 |
| Total | 100.00 | 100.00 |

Sample with MASK β

| | Sample Size (g) | 100 |
|---|---|---|
| Ingredients | % | g |
| Doble shot espresso | 99.95 | 99.95 |
| MASK β | 0.05 | 0.05 |
| Total | 100.00 | 100.00 |

A panel of 10 participants performed a blind test comparing the attributes of the control sample with the sample containing MASK β. They evaluated the differences between the following attributes: sweetness, bitterness, coffee Notes, toasted notes, mouthfeel, impact on Smell, impact on taste.

All of these attributes are scored on a scale from 0-10 in terms of how they are perceived by the panel.

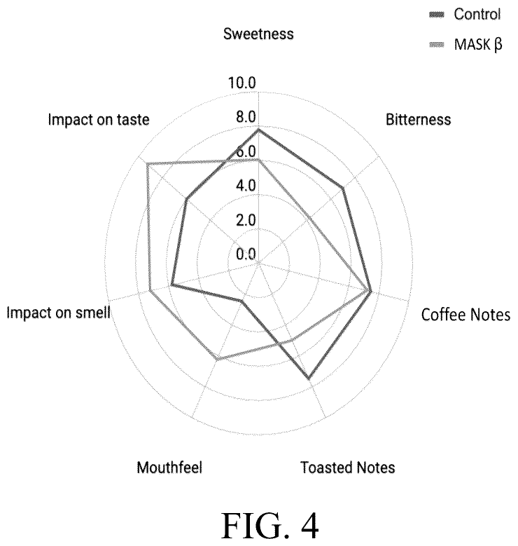

FIG. 4 presents a QDA chart describing the difference between the control sample and the sample containing 0.05% of MASK β. As can be seen from the results, adding 0.05% of MASK R has the following effects: It lowers the sweetness intensity, significantly reduces the bitter notes, increases the flavor impact, without the bitter notes being overwhelming, as they have less impact. The coffee notes, along with the toasted notes, achieve a balanced flavor profile.

In terms of mouthfeel, smoothness is achieved, making the drink feel less “grainy”

MASK α Added to Chamoy (a Mexican Sauce that is Sweet, Salty, Sour and Spicy at the Same Time)

The objective was to mask the aftertaste of sweeteners.

### Control Formulation

| | Sample Size (g) | 100 |
|---|---|---|
| Ingredients | % | g |
| Chamoy “Come Verde” | 100 | 100 |
| Total | 100.00 | 100.00 |

Sample with MASK α

| | Sample Size (g) | 100 |
|---|---|---|
| Ingredients | % | g |
| Chamoy “Come Verde” | 99.90 | 99.90 |
| MASK α | 0.10 | 0.10 |
| Total | 100.00 | 100.00 |

A panel of 8 participants performed a blind test comparing the attributes of the control sample with the sample containing MASK α. They evaluated the differences between the following attributes: sweetness, acidity, spiciness, aftertaste, impact on mouthfeel, impact on smell, impact on taste.

All of these attributes are scored on a scale from 0-10 in terms of how they are perceived by the panel. 0.1% MASK α was α was used with the Chamoy (Come Verde)

The following were the results of the MASK α added to the chamoy. The sweetness was not very prominent in the chamoy, and therefore did not have a significant impact on the product.

However, the acidity was reduced from 7 to 4 points, which made the spiciness of the product stand out slightly more.

Moreover, the stevia aftertaste was not very noticeable in the control, so adding MASK helped to round out the flavor and mask any residual aftertaste that might have been present.

Additionally, the mouthfeel of the product was perceived as denser with the addition of MASK (MASK α)
Finally, the overall impact on the product's flavor was perceived as more balanced compared to the control.

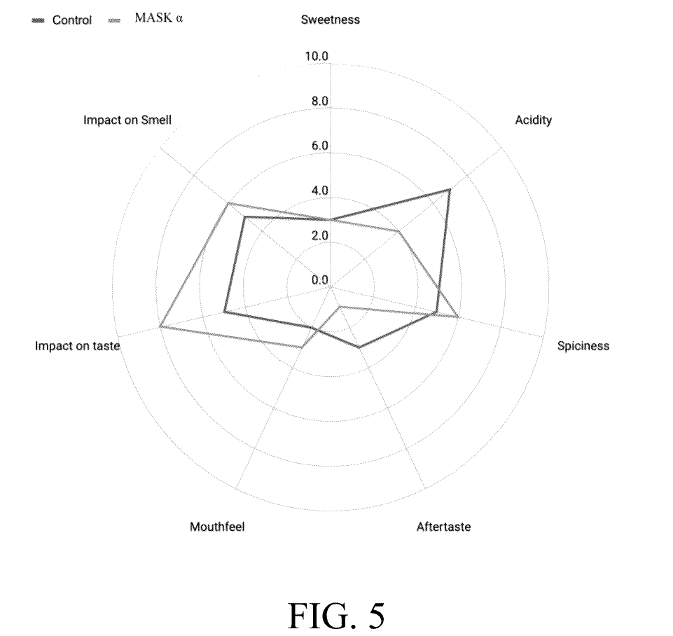

FIG. 5 shows the QDA chart of the chamoy with MASK α.

### MASK and Café Ready-to-Drink (RTD)

The objective of this experiment was to investigate the possibility of masking the bitter notes of coffee in a ready-to-drink beverage. The interaction of various ingredients and additives with the sensory profile of coffee, specifically its bitter taste, was explored in order to enhance the organoleptic experience for the consumer.

### Control Formulation

| | Sample Size (g) | 100 |
|---|---|---|
| Ingredients | % | g |
| RTD Latte | 100 | 100 |
| Total | 100.00 | 100.00 |

Sample with MASK β

| | Sample Size (g) | 100 |
|---|---|---|
| Ingredients | % | g |
| RTD Latte | 99.985 | 99.985 |
| MASK β | 0.015 | 0.015 |
| Total | 100.00 | 100.00 |

A panel of 6 participants performed a blind test comparing the attributes of the control sample with the sample containing MASK β. They evaluated the differences between the following attributes: sweetness, bitterness, coffee notes, caramel notes, vanilla flavor, impact on mouthfeel, impact on smell, impact on taste.

All of these attributes are scored on a scale from 0-10 in terms of how they are perceived by the panel.

MASK β was added to RTD Latte at 0.015% by weight amount.

The following explains the general effects of adding MASK β to Nescafe RTD Latte:

The beverage is perceived as slightly sweeter.

The addition of MASK β increases the caramel notes increase from 4 points to 8.

The vanilla notes increase slightly.

The mouthfeel is perceived as creamier.

Finally, the overall impact is generally perceived as sweetened milk due to the nature of the product.

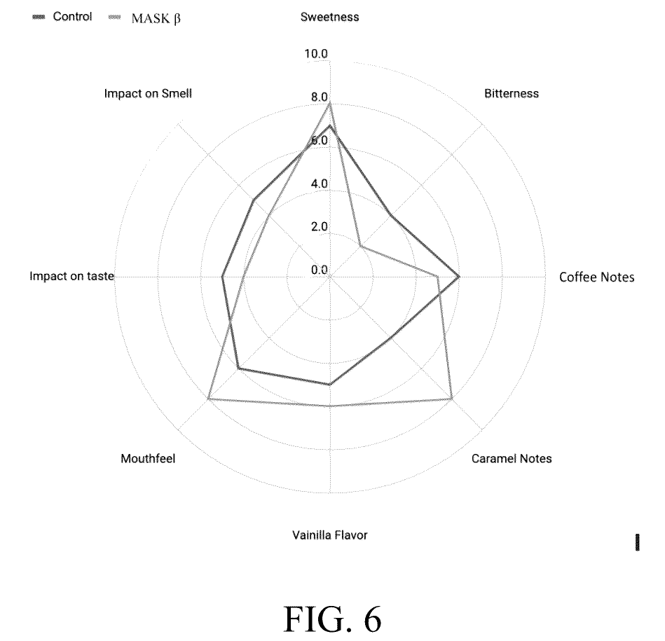

FIG. 6 shows the QDA chart of Nescafe RTD Latte with MASK β.

MASK β Added to Café Con Leche GUD (Coffee with Milk)

The objective was to make a beverage formulated with oats, coconut cream, and vitamins, wherein the objective was to use MASK β to eliminate any aftertastes that these ingredients may leave, as well as to improve the sensory experience in terms of texture, while simultaneously enhancing the flavor profile of the drink.

### Control Formulation

| | Sample Size (g) | 100 |
|---|---|---|
| Ingredients | % | g |
| Coffee with milk | 100 | 100 |
| Total | 100.00 | 100.00 |

Sample with MASK β

| | Sample Size (g) | 100 |
|---|---|---|
| Ingredients | % | g |
| Coffee with milk | 99.93 | 99.93 |
| MASK β | 0.070 | 0.070 |
| Total | 100.00 | 100.00 |

A panel of 8 participants performed a blind test comparing the attributes of the control sample with the sample containing MASK β. They evaluated the differences between the following attributes: sweetness, bitterness, coffee notes, caramel notes, milk notes, mouthfeel, impact on smell, impact on taste. The following were the results of the addition of the MASK β to coffee with milk.

The addition of MASK β lowered the sweetness intensity, significantly reduced the bitter notes, and enhanced the milk and caramel flavor notes. The mouthfeel improved considerably.

The addition created an adequate balance of all the flavors, resulting in a sensory experience that the panelists highly appreciated.

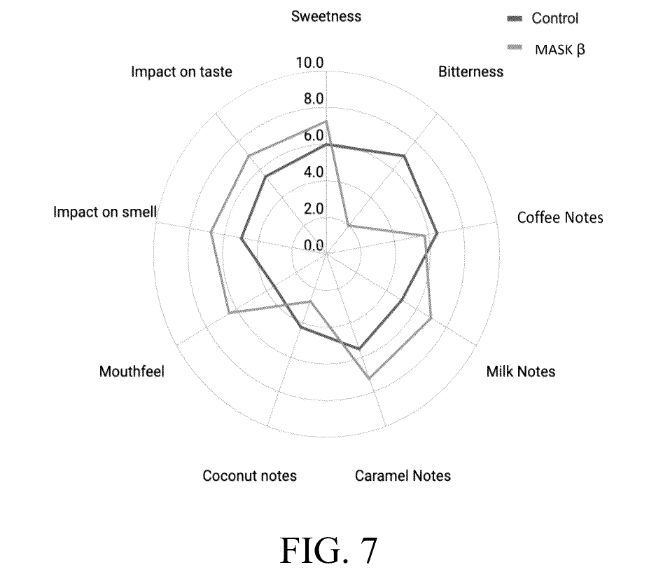

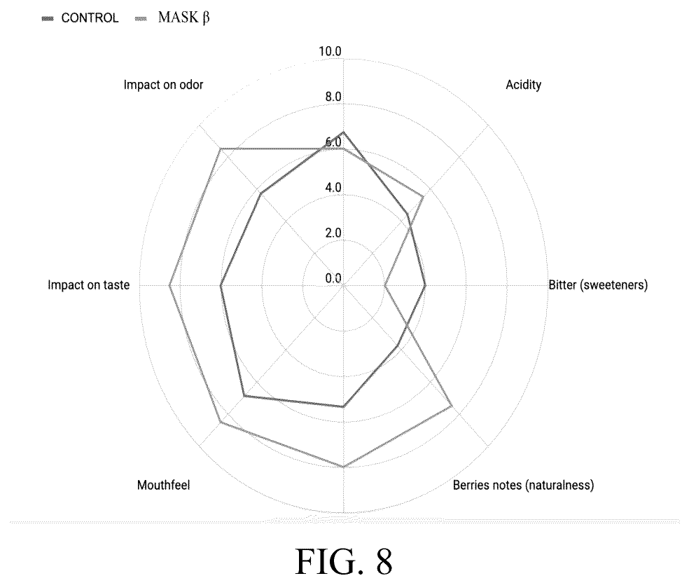

FIG. 7 shows the QDA chart of MASK β added to the coffee with milk

Yogurt with Berries and MASK β

The objective was to eliminate or reduce the aftertaste of the sweeteners used, as well as to enhance the berry flavors. Additionally, the MASK β addition aimed to improve the mouthfeel by enhancing the texture.

### Control Formulation

| | Sample Size (g) | 100 |
|---|---|---|
| Ingredients | % | g |
| Yogurt with berries | 100 | 100 |
| Total | 100.00 | 100.00 |

Sample with MASK β

| | Sample Size (g) | 100 |
|---|---|---|
| Ingredients | % | g |
| Yogurt with berries | 99.95 | 99.95 |
| MASK β | 0.05 | 0.05 |
| Total | 100.00 | 100.00 |

A panel of 15 participants performed a blind test comparing the attributes of the control sample with the sample containing MASK β. They evaluated the differences between the following attributes: sweetness, acidity, bitterness (sweeteners), berries notes (naturalness), pulpy notes, mouthfeel, impact on smell, impact on taste.

All of these attributes are scored on a scale from 0-10 in terms of how they are perceived by the panel.

The following parameters were affected by adding MASK β to the Yogurt with berries. The addition of adding MASK β to the Yoplait lightly reduced the sweetness.

It increases the perception of acidity and reduced the bitter notes caused by the sweeteners used. The rest of the flavor attributes were positively affected, as the yogurt was perceived as much more creamy, more natural, with a stronger presence of berries flavor.

It improved the mouthfeel. Both the flavor and aroma impact were better compared to the control sample.

FIG. 8 shows the QDA chart of adding MASK β to the Yogurt with berries.

MASK β added to Double Shot of Espresso

The objective was to reduce the vitamin notes that may appear in the beverage, as well as slightly reduce the “bean” notes present in it. Although the beverage is not flavored nor does it contain sweeteners, the presence of some of these notes may give the taste of it being “normal,” but the aftertaste of vitamins should not be.

MASK β was added at 0.07% by weight.

The effect of adding MASK β to the double espresso gave the following qualities.

The bitter notes were reduced.

The sweetness intensity was lowered.

The bean and green notes were significantly reduced, but the inherent flavor of the beverage was not adversely affected. With the reduction of these attributes, the flavor and aroma intensity increased, but in a balanced way, without highlighting unpleasant notes, such as those of beans.

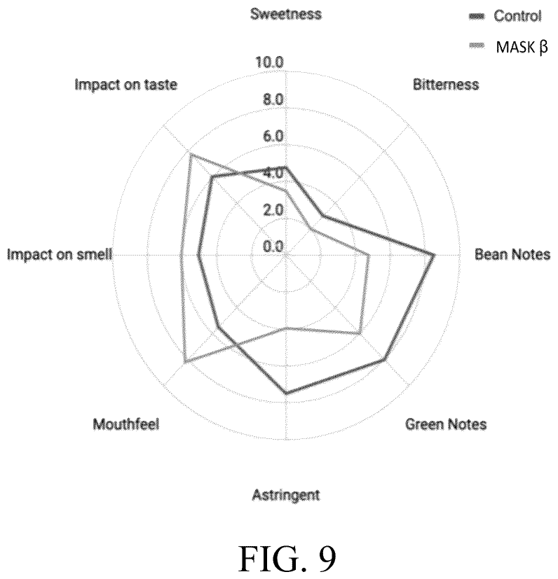

FIG. 9 shows the QDA chart of adding MASK β to the double espresso.

MASK α added to Vanilla Pea Protein Drink

MASK α was added at an amount that was 0.1% by weight.

The addition of MASK α to Vanilla Pea Protein Drink resulted in the following qualities.

It reduced bitterness.

It reduced green “cardboardy” notes.

It increased vanilla taste.

It increased cinnamon taste.

It reduced metallic taste.

It gave a better mouthfeel.

It had a positive impact on smell.

It had a positive impact on taste.

It increased the sweetness perception.

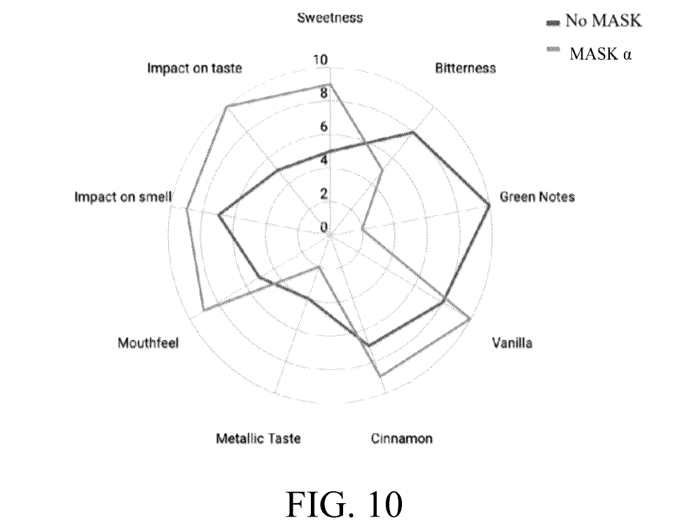

FIG. 10 shows the QDA chart of MASK α added to Vanilla Pea Protein Drink.

Both MASK-1 and MASK-2 were effective at masking the undesirable qualities of the products tested. Mask with Peach Juice and Stevia gave a 93% positive effect from consumers of MASK on reducing aftertaste and off notes. 77% of consumers noted a positive effect on improved mouthfeel in the peach juice with stevia. 98% of consumers noted a positive effect on masking aftertaste and off notes on a pea protein vanilla drink. 94% of consumers noted a positive effect on masking and improved mouthfeel in the pear protein vanilla drink.

The compounds that can be extracted from Lemna sp include specific aroma chemicals that modulate flavors, improve mouthfeel and potentiate sweetness while masking off notes. Other compounds that can be extracted include soluble fiber oligosaccharides, which provide a sweetness to the food product.

Lemna Extract (Lemna gibba) is derived from the whole plant (leaves, stems, and roots) cultivated and harvested in the Bajío region of Mexico, specifically in Querétaro (coordinates 20.5888° N, 100.38990 W). The harvest occurs during the mature vegetative phase to maximize the content of bioactive compounds.

The extraction process utilizes a water-based solvent method, followed by low-pressure evaporation. The resulting complex mixture is chemically characterized to identify both volatile and non-volatile compounds. Advanced analytical techniques, including gas chromatography-mass spectrometry (GC-MS) and ultra-high-performance liquid chromatography-mass spectrometry (UHPLC-MS), were employed to ensure precise identification of chemical constituents.

Quantification of total polyphenols and flavonoids was performed using visible spectroscopy. The Folin-Ciocalteu method (Zenil Lugo et al., 2014) was used for polyphenols, while the aluminum chloride method (Shraim et al., 2021) was applied for flavonoids. The obtained data is incorporated into a mass balance (Table 2), with moisture content utilized to determine total solids. The proportions of carbohydrates (derived from glycerol), proteins, and ash were adjusted accordingly to calculate the residual solids in the sample. This analysis revealed a content of 0.055 g of polyphenols and 0.062 g of flavonoids, with 0.41% attributed to other unidentified compounds.

Experiments were performed to identify the volatile and non-volatile compounds, with a focus on phenols and flavonoids categorized into their respective chemical classes. Two extract batches were evaluated for total phenols, total flavonoids, and bromatological properties.

As the total concentration of flavonoids and phenols constitutes less than 0.1% of the extract composition, these compounds are classified as Class I according to the Cramer Decision Tree (Cohen et al., 2018). This classification indicates low expected oral toxicity, supporting the extract's safety under the intended conditions of use.

Identification and characterization of the various substituents and their amounts were made of the MASK products that were used. The results of this analysis can be seen below in

TABLE 2
Composition of MASK.

| | Industry | Industry | |
|---|---|---|---|
| Component | Analysis 1% | Analysis 2% | Mean |
| Carbohydrates | 39.27 | 39.18 | 39.23 ± 0.06 |
| Protein | 0.87 | 1.09 | 0.98 ± 0.16 |
| Total Polyphenols | 0.06 | 0.06 | 0.06 ± 0.0 |
| Total Flavonoids | 0.06 | 0.06 | 0.06 ± 0.0 |
| Ash | 1.35 | 1.27 | 1.31 ± 0.6 |
| Moisture | 58.00 | 57.90 | 57.95 ± 0.7 |
| Other constituents | 0.39 | 0.44 | 0.42 ± 0.4 |

Thus, from the above examples, experiments, and tables, it should be apparent that MASK provides good masking ability.

### FLORA Examples

### Objective

The objective of this experiment is to assess the impact of incorporating the FLORA ingredient (the compositional extract and/or isolation product described herein) into water-based mango ice cream and its influence on the melting percentage. Through controlled variations in FLORA dosage, we aim to investigate its stabilizing and texture-enhancing properties, ultimately determining its effectiveness in reducing the melting percentage of mango ice cream. The results will contribute valuable insights into the potential benefits of utilizing FLORA as a stabilizing agent in ice cream formulations, with implications for product quality, consumer satisfaction, and commercial viability.

### Materials

The materials employed in this experimental investigation consist of mango powder (with a solid content of 75%), refined sugar, corn syrup (Karo baby brand), arabic gum, guar gum, distilled water, and samples derived from distinct batches of the FLORA ingredient. The selection of these constituents was meticulous, aiming to establish controlled conditions for the formulation of mango-flavored ice cream. Each ingredient was chosen for its specific properties, contributing to a nuanced assessment of the influence of FLORA on the critical attributes of the final ice cream product.

### Experimental Procedure

### Ice Cream Preparation

A total of 250 grams of water-based mango ice cream was prepared following these steps: 0.15 grams of guar and arabic gum were added, followed by the incorporation of 25 grams of refined sugar and 0.25 grams of FLORA into the mixture. The powder blend was completely dissolved in 187 grams of water, and 17.5 grams of mango powder were added. The mixture was heated to 80° C. for 8 minutes, tempered to 40° C., and allowed to rest in refrigeration for at least two hours. Subsequently, the mixture was placed in plastic molds of 60 mL and frozen at −3° C. for 24 hours. These steps represent the methodology employed to create the water-based mango ice cream for the experiment, ensuring the uniform incorporation of ingredients and controlled freezing conditions.

### Melting Curve Preparation

Ice cream samples of 60 mL were placed in a freezer at −12° C. for 60 minutes and then transferred onto a 5 mm metal mesh positioned over a plastic funnel inserted into a 100 mL graduated cylinder, which was set on an electronic balance (Scout-Pro®, Ohaus, New Jersey, U.S.A.). The test was conducted at room temperature (24±1° C.). Readings of the melted volume were taken every 5 minutes, and images of the ice cream were captured to assess shape retention. From the collected data, a time-versus-melted volume graph was constructed.

### Results and Data Analysis

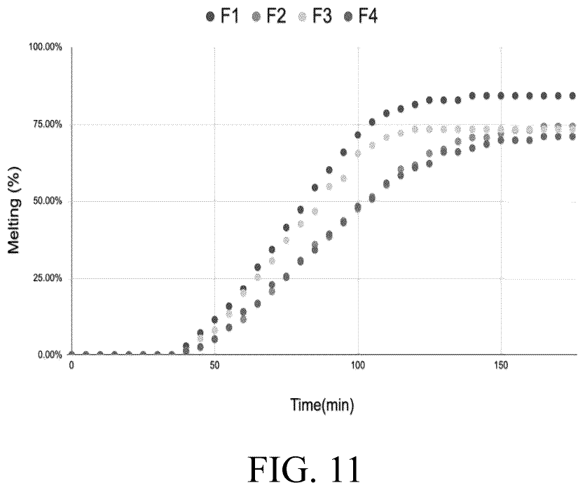

The graph shown in FIG. 11 presents the results of the melting curve for four different samples, where F1 represents the control without FLORA, F2: FLORA 1, F3: FLORA 2, and F4: FLORA 3. Each of these samples was extracted from different Lemna sp. production batches, and in the current experiment, their effect on the melting percentage of a water-based mango-flavored ice cream was assessed. The results of the melting curve for these four samples are displayed in the graph, providing insight into the impact of FLORA on the melting characteristics of the mango-flavored water-based ice cream. As can be seen in FIG. 11, the control melts at an earlier time than the three FLORA-containing batches. Note that not only does the control melt more quickly, even after 3 hours, but the control has more melted water-based mango-flavored ice cream. In particular, the melting percentage in the control sample is 84.29%, in F2: 74.36%, in F3: 73.33%, and F4: 70.89%. This unequivocally demonstrates that the incorporation of FLORA in ice cream formulations significantly decreases the melting percentage.

The observed decrease in melting rates across FLORA-treated samples underscores the effectiveness of FLORA as a stabilizing agent in ice cream formulations, suggesting its promising role in enhancing the overall quality and stability of the frozen dessert. These findings advocate for further exploration and utilization of FLORA in the ice cream industry, opening avenues for improved product performance and consumer satisfaction. This ability to delay and decrease melting may be advantageously used when ice cream is bought at a store and is subsequently taken home meaning that during this transport time, the ice cream will stay in a better still-frozen state. Moreover, magnified close-up pictures of the ice cream revealed that the addition of FLORA to ice cream creates an ice cream with smaller crystals. The amount and size of ice crystallization is an important factor that determines an ice cream's final quality. The smaller the ice crystal size is in the final product, the better the quality is. Large ice crystals cause a coarse, grainy, and icy texture in ice cream. Thus, the addition of FLORA not only created better melt properties in the ice cream but also provided an ice cream that was unexpectedly better in quality.

### Objective

The objective of this experiment is to systematically assess and compare the sweetness potential of different batches of the FLORA ingredient within a simple matrix of water, sugar, and the FLORA ingredient. The goal is to quantify and characterize the sweetness levels imparted by various FLORA batches, contributing valuable insights into its potential as a sweetening potentiating and/or enhancing agent on a defined sweetness scale.

### Materials

The materials employed in this scientific investigation include refined sugar, water, and samples derived from various batches of the FLORA ingredient. Refined sugar served as a key component to establish a standardized sweetness baseline, while water provided the matrix for experimental formulations. The diverse samples from different FLORA batches were crucial for assessing the variability and consistency of the FLORA ingredient across the experimental conditions. This controlled selection of materials ensured a comprehensive exploration of the sweetness potential and characteristics of FLORA within the defined experimental framework.

### Experimental Procedure

### Sugared-Water Matrices Preparation

A 150 mL sugar solution was prepared for this experiment. In the control group, 135 mL of water and 15 grams of sugar were added (representing 10% of the total mix). For the FLORA samples, the solution consisted of 135 mL of water, 13.5 grams of refined sugar (representing 9% of the total mix), and 1.5 grams of FLORA (representing only 1% of the total mix). The solutions were heated at 80° C. with constant stirring to ensure the complete solubilization of the components. This ensured a consistent base for evaluating the impact of FLORA on the characteristics of the sugar solution.

### Sensory Analysis

A sensory analysis was conducted using a scale ranging from 1 to 9, where 9 represents the maximum value. The number 3 on the scale corresponds to a 10% sugar content and serves as the reference value. Subsequently, each solution was evaluated by an untrained panel of 6 individuals. The assessment focused on comparing the sweetness and duration of each solution relative to the reference with a value of 3. This systematic approach aimed to quantitatively assess and compare the perceived sweetness and lingering taste of the solutions under scrutiny.

### Results and Data Analysis

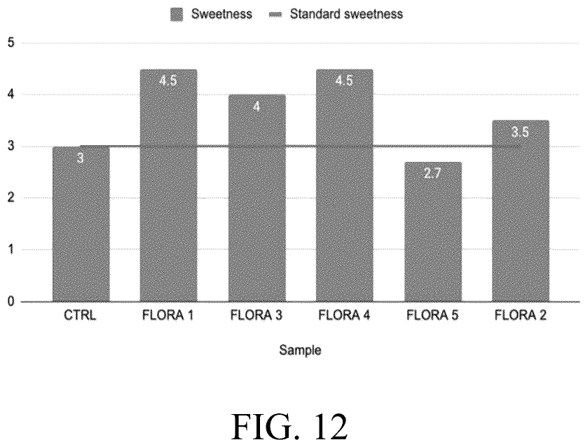

FIG. 12 presents a comparative table among all samples, evaluating the numerical sweetness value. The standard sugar value (3) is marked in red on the graph. As observed, FLORA 1, FLORA 3, FLORA 4, and FLORA 2 exhibit higher values than the reference, with the mean perceived sweetness values being 4.5, 4, 4.5, and 3.5, respectively. The samples containing FLORA even contained 10% less sugar than the control and still displayed higher perceived sweetness values. For example, a value of 4.5 represents an increase in 50% of perceived sweetness in a sample that was reduced in sugar by 10%. This highlights the advantage of FLORA in enhancing sweetness levels. Thus, the addition of FLORA not only imparts qualities such as the ability to delay or decrease melting (of ice cream) but it also imparts sweetness beyond the sweetness of a control (that does not contain the pectin-containing extract).

### Graph of Sweetness Standard Comparative Between Different Samples of FLORA and a Reference.

Referring to FIG. 12, the duration of sweetness during consumption is evaluated. The longest durations are observed in FLORA 1, FLORA 3, FLORA 4, and FLORA 2, with FLORA 3 exhibiting the most significant effect.

It should be understood that minor modifications can be made, resulting in different compounds within the compositional mix being present at higher levels. For example, employing techniques known to those skilled in the art, the amount of carbohydrate in the mix may be increased relative to the levels of protein, fatty acids, or any other components by using methods that maximize the desired compound's presence in the composition. Such techniques may include the use of different extraction solvents, centrifugation (including differential density media), dialysis membranes, filtration, various lysis methods, and other purification processes to alter the compositional makeup. Modifying the composition enables the enhancement of specific beneficial effects, such as improving mouthfeel, texture, flavor enhancement, masking, sweetness potentiation, melting properties, or other desired attributes.

Furthermore, altering the extraction process can result in compositions with lower performance characteristics. For example, reducing the efficiency of the extraction or modifying the solvents or techniques used may lead to compositions with less effective flavor masking, lower sweetness potentiation, or reduced texture enhancement. Such modifications may be employed intentionally to meet specific product requirements or to optimize cost-effectiveness, where less intense effects are desired.

In one embodiment, the compositions disclosed herein can also be used to isolate compositional make-ups from various feedstocks other than duckweed, such as food waste. Extracted and/or isolated products (which may be compositions) will exhibit their unique compositional makeup, which may include varying amounts of pectin-containing products, carbohydrates, proteins, fatty acids, minerals, and/or vitamins. For example, in one embodiment, the extraction or isolation process may result in a composition slightly different from those described herein, derived from feedstocks such as potatoes and/or onions. These feedstocks, particularly at certain stages of ripeness, may otherwise be considered unpalatable for human consumption.

### Experiments

Experiments were also conducted to ascertain various properties of the FLORA disclosed herein including their ability to enhance or potentiate sweetness relative to sweeteners, their ability to create permanent flavors (e.g., duration of sweetness and masking of unpleasant off notes) relative to sweeteners and their properties as they relate to aftertaste.

In order to avoid using sugar, many formulations now include sugar substitutes or artificial sweeteners. Sugar substitutes are chemical or plant-based substances used to sweeten or enhance the flavor of foods and drinks. They are also known as “artificial sweeteners” or “non-caloric sweeteners.” Some sugar substitutes are low in calories. Others have little to no calories.

Most sugar substitutes are many times sweeter than sugar. It takes a smaller amount of these sugar substitutes to provide the same level of sweetness. Other sugar substitutes called sugar alcohols are not as sweet as sugar.

Sugar substitutes can be used as a tabletop sweetener and/or as an ingredient in processed foods and drinks, particularly those labeled sugar-free or diet. That includes soft drinks, candy and baked goods.

Sugar substitutes are regulated as food additives by the U.S. Food and Drug Administration (FDA). This means that the FDA reviews scientific evidence to be sure that a sugar substitute is safe before it can be used in foods and drinks.

However, one of the principal drawbacks of sweeteners is their aftertaste. The aftertaste of sweeteners is most often described as bitter or metallic. According to several studies, sugar substitutes cause an aftertaste because they activate not only the sweet taste receptor on our tongue but they also activate the bitter taste receptors.

### Objective

This experiment aims to systematically assess and compare the impact of the FLORA ingredient on sweetness enhancement potential, persistence or duration of sweetness, and masking of unpleasant off-notes and aftertastes within a simple matrix of water, sweetener, and the FLORA ingredient. The objective is to quantify and characterize the sweetness levels, permanence or duration effects, and masking of off-notes and aftertaste imparted by the sweetener with and without FLORA ingredient, providing valuable insights into its potential on a defined scale of perceived sweetness, sweetness duration or permanence, and masking off-notes or aftertaste.

### Materials

The materials employed in this scientific investigation include sucralose, stevia, allulose, monk fruit, chicory inulin, and erythritol, water, and samples of the FLORA ingredient. Sweeteners served as a key component to establish a standardized sweetness baseline, while water provided the matrix for experimental formulations. The sweetness level was established on a 9-point scale, where 3 corresponds to a control solution with 10% of sucrose. In comparison to this, the sweetness permanence and aftertaste were assessed for each sweetener with and without FLORA.

### Experimental Procedure

Solutions of each sweetener were prepared with the theoretical dose indicated for each to provide a sweetness comparable to the sugar control (10%), along with a solution containing the same amount of sweetener and 0.10% FLORA. The solutions were heated at 80° C. with constant stirring to ensure the complete solubilization of the components. This ensured a consistent base for evaluating the impact of FLORA on the characteristics of the sugar solution.

### Sensory Analysis

A sensory analysis was conducted using a scale ranging from 1 to 9, where 9 represents the maximum value. The number 3 on the scale corresponds to a 10% sugar content and serves as the reference value. Subsequently, each solution was evaluated by an untrained panel of 6 individuals. The assessment focused on comparing the sweetness and duration of each solution relative to the reference with a value of 3. This systematic approach aimed to quantitatively assess and compare the perceived sweetness, sweetness permanence, and aftertaste of the solutions under evaluation.

### Results and Data Analysis

### Comparison of Sweetness Between Different Sample Sweeteners and Flora.

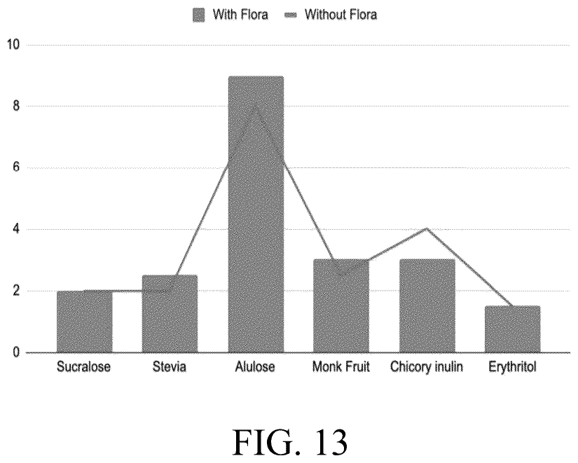

FIG. 13 below presents a comparative table among all samples, evaluating the numerical sweetness value. The value of the red line represents the perceived sweetness of the sweetener without FLORA, while the blue bar represents the perceived sweetness with the added ingredient. It can be observed that in some cases, it enhances, in others, it remains the same, and in the case of inulin, it is perceived as lower when FLORA is added. It should be noted that the result with Alulosa demonstrated better performance compared to the other sweeteners, exhibiting a more pronounced enhancement in sweetness.

### Flavor Permanence Comparison Between Different Samples Sweeteners and FLORA.

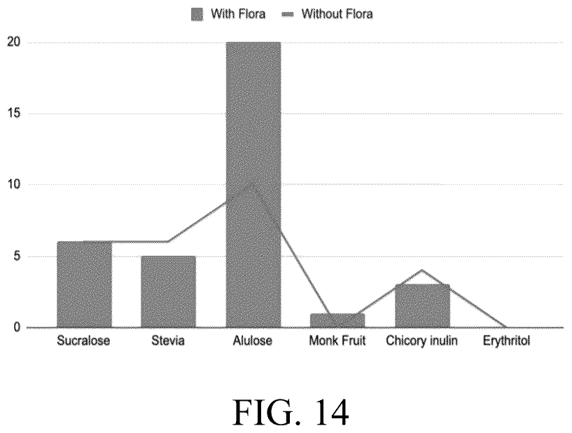

Turning to FIG. 14, the duration of the taste of each sweetener is evaluated, and it can be observed that the only significant difference is with allulose, where the permanence time with FLORA is double compared to allulose alone.

### Aftertaste Comparison Between Different Samples Sweeteners and FLORA.

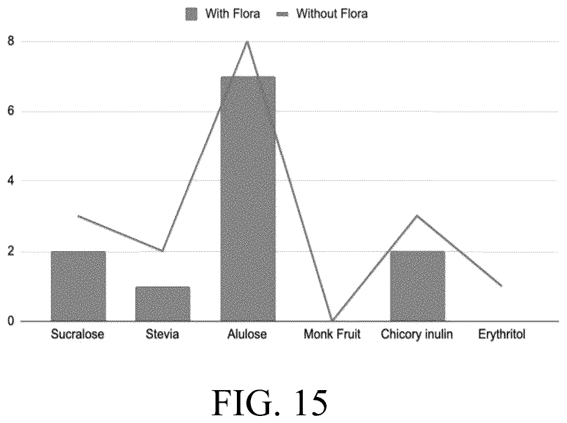

Finally, in FIG. 15, the results of the aftertaste evaluation of each sweetener with and without the addition of the ingredient are shown. It is observed that in all sweeteners, the aftertaste (or off-notes) decreases when FLORA is added, except for monk fruit, which does not have an aftertaste on its own. Therefore, the flavor perception is better when it includes FLORA.

### FLORA Properties

In an embodiment, the present invention relates to a composition that comprises an extraction product from duckweed, said extraction product having a property of being able to delay and/or decrease a melting of ice cream.

In a variation, the extraction product further comprises an ability to add sweetness to a food product. In a variation, the extraction product leads to the decrease in the melting of ice cream that is by about 88% relative to a control. By 88% it means that the control melts more than the composition that comprises the extraction product, so that if the control is set to 100%, the composition comprising the extraction product undergoes 88% of the melting of the control. In a variation, product takes at least about 20 minutes more for the ice cream to melt 50% at room temperature. This means that the control melts faster so that it takes at least about 20 minutes longer for the composition that comprises the extraction product to have 50% of the ice cream mass melt. In a variation, the extraction product is able to potentiate and/or enhance 1.16 to 1.50 more sweetness (equivalent to 39% or 50% more sweetness) to the food product relative to a control, while decreasing the sugar content 10%. In a variation, the extraction product comprises a complex blend of volatile and non-volatile compounds. Among these are aromatic compounds, such as phenols, flavonoids, and certain terpenes, which contribute to a pleasant fragrance. Additionally, the composition includes pectin, other carbohydrates, proteins, fibers, vitamins, minerals, antioxidants, and fatty acids.

In a variation, the composition or the extraction product comprises all of pectin, fiber, other carbohydrates, fatty acids, vitamins, and minerals. In a variation, extraction product further comprises protein.

In an embodiment, the extraction product is derived from a duckweed product wherein a first extraction step comprises extracting components from the duckweed wherein the duckweed is part of a liquid or fluid. It should be understood that the duckweed may be present in solution or as a dispersion such as a colloid or a precipitate. In an embodiment, if the duckweed is present as a solution, the solution comprises a liquid in which duckweed is substantially soluble.

In a variation, the ice cream is mango-flavored ice cream. In a variation, the extraction product comprises pectin and the extraction product further comprises the ability to be used as a masking agent to a food product. In a variation, the extraction product further comprises a complete protein. In a variation, the benefits and performance of the product as a masking agent, the sweetness potentiator and the other beneficial properties are to the inventors' belief effectuated by the presence of the pectin-containing product, the fibers, and/or the other carbohydrates. It is believed that the masking ability derives primarily from a mixture of the components whereas the pleasing texture derives mainly from the presence of pectin. The fact that there may also be beneficial properties that derive from the protein components, the fatty acids, the minerals and the vitamins, are a bonus beyond the benefits derived from the pectin containing component, the fibers, and the other carbohydrates.

In an embodiment, the present invention relates to a method of delaying and/or decreasing the melting of ice cream comprising: adding an extraction product from plant material like duckweed to ice cream while the ice cream is being made, making the ice cream, and allowing the ice cream to melt. In a variation, the extraction product leads to the decrease in the melting of ice cream that is by about 88% relative to a control. In a variation, the extraction product takes at least about 20 minutes more for the ice cream to melt 50% at room temperature. In a variation, the extraction product further comprises an ability to add sweetness to a food product. In a variation, the extraction product potentiate and/or enhance 1.16 to 1.50 more sweetness (equivalent to 39% or 50% more sweetness) to the food product relative to a control. In a variation, the ice cream is mango-flavored ice cream. In a variation, the extraction product comprises pectin, fiber, other carbohydrates, protein, fatty acids, vitamins, and minerals. In a variation, the extraction product further comprises a complete protein. In a variation, the extraction product comprises pectin and the extraction product further comprises the ability to be used as a masking agent to a food product.

### MASK Properties

In an embodiment, the present invention relates to composition that comprises an extraction product from duckweed, wherein the composition when added to a food or drink product comprises an ability to mask and/or block and/or suppress taste receptors to avoid off tastes and/or bad flavors and/or works by using aromatic compounds to modulate the flavors.

In a variation, the food or drink product is one or more products selected from the group consisting of stevia, coffee, agave syrup, espresso with oats, coconut cream, and vitamins, chamoy come verde, yogurt, and a soy drink. In a variation, the extraction product is a solid or a liquid. In a variation, the extraction product masks an aftertaste and off notes of the food or drink product and/or leads to improved mouthfeel relative to a food or drink product that has not had the extraction product added. In a variation, the extraction product comprises aromatic compounds (in the smell sense and not in the Hückel aromaticity sense) comprising an aldehyde, an ester, a ketone, and/or an alcohol. In a variation, the extraction product comprises pectin, and one more of fiber, other carbohydrates, protein, fatty acids, vitamins, and minerals. In a variation, the composition further comprises a stabilizer. In a variation, the stabilizer is glycerol.

n a variation, the food or drink product is coffee, which is espresso. In a variation, the extraction product improves one or more attributes in the food or drink product relative to the food or drink product that has not been treated with the composition, the attributes selected from the group consisting of sweetness, acidity, spiciness, aftertaste, bitterness, coffee notes, bean notes, green notes, caramel notes, milk notes, vanilla flavor, metallic taste, natural profile, pulpy notes, fruity notes, blueberry notes, berry notes, alcohol notes, astringency, toasted notes, mouthfeel, impact on smell, impact on mouthfeel, and impact on taste. In a variation, the extraction product improves mouthfeel and/or creaminess.

In a variation, the feedstock material that is used (i.e., duckweed) has a mix of specific volatile and non-volatile compounds that can be extracted with special functionalities that are difficult to obtain from other sources.

In a variation, the extraction product comprises between 39-40% by weight carbohydrate, between 0.85%-1.1% by weight protein, wherein a sum of polyphenols, flavonoids and ash is between 1 and 1.5% by weight, a moisture content between 57% and 58% by weight, and wherein other compounds are present at less than 1% by weight. In a variation, the extraction product is amber in color, and comprises an amount of lead that is less than 0.250 mg/L, an amount of mercury less than 0.050 mg/L, an amount of arsenic less than 0.100 mg/L, and an amount of cadmium less than 0.025 mg/L.

In an embodiment, the present invention relates to a method of masking off tastes and/or bad flavors in a food or drink product, comprising administering to the food or drink product an extraction product from duckweed, the extraction product further comprising aromatic compounds. In a variation, the extraction product is a liquid or solid. In a variation, the solid is a powder. In a variation, the extraction product further comprises an ability to add sweetness to a food product.

In an embodiment, the present invention relates to a food or drink product that comprises an extraction product from duckweed, the food or drink product comprising one or more positive or negative attributes selected from the group consisting of sweetness, acidity, spiciness, aftertaste, bitterness, coffee notes, bean notes, green notes, caramel notes, milk notes, vanilla flavor, metallic taste, pulpy notes, fruity notes, blueberry notes, berry notes, alcohol notes, astringency, toasted notes, poor mouthfeel, poor smell, poor mouthfeel, and poor taste, the extraction product being able to at least partially ameliorate the negative attributes and/or accentuate the positive attributes. In a variation, the food or drink product is selected from the group consisting of stevia, coffee, agave syrup, espresso with oats, coconut cream, and vitamins, chamoy come verde, yogurt, and a soy drink. In a variation, the attribute is a negative attribute.

In an embodiment, the present invention relates to a duckweed extract composition, the extract composition comprising:
i. 0.5% to 45% protein by weight,
ii. 20% to 65% carbohydrates by weight,
iii. 0.2% to 4% fat by weight, and
iv. 2% to 60% water by weight.

Alternatively, in a variation, the extract composition comprises:
i. 6% to 30% protein by weight,
ii. 25% to 60% carbohydrates by weight,
iii. 0.5% to 3% fat by weight, and
iv. 2% to 7.5% water by weight.

Alternatively, in a variation, the extract composition comprises:
i. 0.9% to 2% protein by weight,
ii. 30% to 50% carbohydrates by weight,
iii. 0.5% to 4% fat by weight, and
iv. 45% to 55.40% water by weight.

In a variation, any of the composition disclosed herein may be formulated as a powder. In a variation, they may be formulated as a liquid.

In a variation, the present invention relates to a method of modulating a characteristic of a food product, wherein the method comprises the step of:
i. Adding and/or mixing a duckweed extract composition according to any composition disclosed herein to a food product, thereby modulating the characteristic of the food product. In an embodiment, a food product may comprise drinks. In an embodiment, a food product may not include drinks. In a variation, modulating the characteristic of the food product comprises decreasing or suppressing at least one of the following characteristics:
i. Bitterness,
ii. Off flavors,
iii. Astringency, and
iv. Any combination thereof.

In a variation, modulating the characteristic of the food product comprises increasing or enhancing at least one of the following characteristics:
i. Fruity flavors,
ii. Caramel notes,
iii. Natural profile, and
iv. Any combination thereof.

In a variation, the food product is selected from the group consisting of:
i. Plant-based protein,
ii. Juices and other beverages,
iii. Meats
iv. Fish, and
v. Bread.

In an embodiment, the present invention relates to an enhanced food product, the product comprising:
i. A food product, and
ii. A duckweed extract composition according to any of the compositions disclosed herein and any form of the product (including powder and/or liquid).

In a variation, the food product is selected from the group consisting of:
i. Vegan products,
ii. Snacks,
iii. Ready to eat meals, and
iv. Beverages.

In an embodiment, the enhanced food product has at least one characteristic beneficially modulated by the duckweed extract composition. In a variation, the extract composition further comprises an aromatic compound. In a variation, the aromatic compound comprises one or more of a phenol, a flavonoid, a terpene, maltol, or vanillin.

The following references are incorporated by reference in their entireties.
Cheng, J. J., & Stomp, A. (2009). Growing Duckweed to Recover Nutrients from Wastewaters and for Production of Fuel Ethanol and Animal Feed. CLEAN—Soil, Air, Water, 37(1), 17-26. Portico. https://doi.org/10.1002/clen.200800210
Gülçin, İ., Kireçci, E., Akkemik, E., Topal, F., & Hisar, O. (2010). Antioxidant and Antimicrobial Activities of an Aquatic Plant: Duckweed (Lemna minor L.). Turkish Journal of Biology. LOCKSS. https://doi.org/10.3906/biy-0806-7
González-Renteria, M., del Carmen Monroy-Dosta, M., Guzmán-García, X., Hernández-Calderas, I., & Ramos-Lopez, M. A. (2020). Antibacterial activity of Lemna minor extracts against Pseudomonas fluorescens and safety evaluation in a zebrafish model. Saudi Journal of Biological Sciences, 27(12), 3465-3473. https://doi.org/10.1016/j.sjbs.2020.09.043
Haustetn, A. T., Gilman, R. H., Skillicorn, P. W., Vergara, V., Guevara, V., & Gastanaduy, A. (1990). Duckweed, A Useful Strategy for Feeding Chickens: Performance of Layers Fed with Sewage-Grown Lemnaceae Species. Poultry Science, 69(11), 1835-1844. https://doi.org/10.3382/ps.0691835

It should be understood and it is contemplated and within the scope of the present invention that any feature that is enumerated above can be combined with any other feature that is enumerated above as long as those features are not incompatible. Whenever ranges are mentioned, any real number that fits within the range of that range is contemplated as an endpoint to generate subranges. In any event, the invention is defined by the below claims.

1. A duckweed extract composition, the extract composition comprising:
i. 0.5% to 45% protein by weight,
ii. 20% to 65% carbohydrates by weight,
iii. 0.2% to 4% fat by weight, and
iv. 2% to 60% water by weight.

2. The composition of claim 1, wherein the composition comprises:
i. 6% to 30% protein by weight,
ii. 25% to 60% carbohydrates by weight,
iii. 0.5% to 3% fat by weight, and
iv. 2% to 7.5% water by weight.

3. The composition of claim 2, formulated as a powder.

4. The composition of claim 1, wherein the composition comprises:
i. 0.9% to 2% protein by weight,
ii. 30% to 50% carbohydrates by weight,
iii. 0.5% to 4% fat by weight, and
iv. 45% to 55.40% water by weight.

5. The composition of claim 4, formulated as a powder.

6. The composition of claim 4, formulated as a liquid.

7. A method of modulating a characteristic of a food product, the method comprising the step of:
i. Adding and/or mixing a duckweed extract composition according to claim 1 to a food product, thereby modulating the characteristic of the food product.

8. A method of modulating a characteristic of a food product, the method comprising the step of:
i. Adding and/or mixing a duckweed extract composition according to claim 2 to a food product, thereby modulating the characteristic of the food product.

9. A method of modulating a characteristic of a food product, the method comprising the step of:
i. Adding and/or mixing a duckweed extract composition according to claim 3 to a food product, thereby modulating the characteristic of the food product.

10. A method of modulating a characteristic of a food product, the method comprising the step of:
i. Adding and/or mixing a duckweed extract composition according to claim 4 to a food product, thereby modulating the characteristic of the food product.

11. A method of modulating a characteristic of a food product, the method comprising the step of:
i. Adding and/or mixing a duckweed extract composition according to claim 5 to a food product, thereby modulating the characteristic of the food product.

12. A method of modulating a characteristic of a food product, the method comprising the step of:
i. Adding and/or mixing a duckweed extract composition according to claim 6 to a food product, thereby modulating the characteristic of the food product.

13. The method of claim 7, wherein modulating the characteristic of the food product comprises decreasing or suppressing at least one of the following characteristics:
i. Bitterness,
ii. Off flavors,
iii. Astringency, and
iv. Any combination thereof.

14. The method of claim 7, wherein modulating the characteristic of the food product comprises increasing or enhancing at least one of the following characteristics:
i. Fruity flavors,
ii. Caramel notes,
iii. Natural profile, and
iv. Any combination thereof.

15. The method of claim 7, wherein the food product is selected from the group consisting of:
i. Plant-based protein,
ii. Juices and other beverages,
iii. Meats
iv. Fish, and
v. Bread.

16. An enhanced food product, the product comprising:
i. A food product, and
ii. A duckweed extract composition according to claim 1.

17. An enhanced food product, the product comprising:
i. A food product, and
ii. A duckweed extract composition according to claim 2.

18. An enhanced food product, the product comprising:
i. A food product, and
ii. A duckweed extract composition according to claim 3.

19. An enhanced food product, the product comprising:
i. A food product, and
ii. A duckweed extract composition according to claim 4.

20. An enhanced food product, the product comprising:
i. A food product, and
ii. A duckweed extract composition according to claim 5.

21. An enhanced food product, the product comprising:
i. A food product, and
ii. A duckweed extract composition according to claim 6.

22. The method of claim 11, wherein the food product is selected from the group consisting of:
i. Vegan products,
ii. Snacks,
iii. Ready to eat meals, and
iv. Beverages.

23. The method of claim 11, wherein the enhanced food product has at least one characteristic beneficially modulated by the duckweed extract composition.

24. The extract composition of claim 1, wherein the extract composition further comprises an aromatic compound.

25. The extract composition of claim 14, wherein the aromatic compound comprises one or more of a phenol, a flavonoid, a terpene, maltol, or vanillin.
